(19) United States
(12) Patent Application Publication
(10) Pub. No.: US 2002/0157649 A1
(43) Pub. Date: Oct. 31, 2002

(54) Method for synchronizing an internal combustion engine based on the angular position of a rotating part

(76) Inventors: Klaus Zimmermann, Wien (AT); Oliver Hasslacher, Leonberg (DE); Bodo Wolf, Bietigheim-Bissingen (DE)

Correspondence Address: Walter Ottesen, P.O. Box 4026, Gaithersburg, MD, 20885-4026, US

(21) Appl. No.: 10/133,389

(22) Filed: Apr. 29, 2002

(30) Foreign Application Priority Data
Apr. 27, 2001 (DE) 101 20 799.9

(51) Int. Cl. F02M 51/00

(52) U.S. Cl. 123/478; 701/105

(57) ABSTRACT

The invention relates to a method for rotational position determination of an internal combustion engine having a camshaft to which a camshaft sensor is assigned and having a crankshaft to which a crankshaft rotational position transducer is assigned. A control apparatus for controlling the engine includes at least one configurable control apparatus input. After detecting a fault function of the crankshaft rotational position transducer, the control apparatus input of the control apparatus switches to the evaluation of one of the flanks (9.1, 10.1, 11.1, 12.1; 9.2, 10.2, 11.2, 12.2) or of all flanks (9.1, 10.1, 11.1, 12.1; 9.2, 10.2, 11.2, 12.2) of pulse segments (A, C, E, G). Thereafter, an injection of fuel takes place into the cylinders of the engine until an rpm gradient is detected which makes possible a position determination of the rotational position of the crankshaft of the engine. After the position determination of the engine, the engine dynamic is determined via evaluation of all segment times (A, B, C, D, E, F, G, H) as well as the injection time point and the duration of the injection operations is determined, adjusted and corrected.

### FIELD OF THE INVENTION

Emergency operation routines are implemented in the control apparatus of modern internal combustion engines in order to prevent a motor vehicle from becoming disabled. This is done so that when a transducer, which detects a rotation or movement of a rotating part, malfunctions, an emergency mode of the control can be maintained in order to continue the travel. Today, rpm transducers, reference signal transducers as well as phase signal transducers are used in internal combustion engines.

### BACKGROUND OF THE INVENTION

German patent publication 33 07 833 A1 discloses a method for triggering operations which are dependent upon the angular position of a rotating part. An arrangement for displaying and/or storing faults of transducer wheel devices on internal combustion engines is disclosed. As components, the following are contained in the transducer arrangement: an rpm transducer, a reference mark transducer and a phase signal transducer. A check of the transducer arrangement is made during operation of the engine. A fault signal is generated when there is a deviation from the prescribed sequence and/or prescribed intervals of the transducer signals. This fault signal is stored and/or supplied to a display device.

German patent publication 43 13 331 A1 relates to a method for triggering operations dependent upon the angular position of a rotating part. Here, these operations are especially the ignition and injection operations in an internal combustion engine. The rotating part has angular marks distributed about its periphery. A first transducer is used to detect the angular position of the rotating part and outputs an angular marking signal when an angular marking rotates. The angular marking signals are counted by a first counter. The operations are triggered in dependence upon the counting result and the proper occurrence of the angular marking signals is checked. Furthermore, a second transducer is provided whose signals are in a fixed arrangement to the angular marking signals of the first transducer. The time clock signals of a clock regenerator belong to the second counting means. After detecting the improper occurrence of angular marking signals, an emergency operation is started wherein at least a first value and a second value are computed from the time-dependent sequence of the signals of the second transducer. The counter reading of the second counting means is compared to the first value and a second value and, when there is a coincidence of the counter reading of the second counting means with the at least one first value of a first flank and when there is coincidence of the counter reading of the second counting means with the at least one second value, a second flank, which is opposite to the first flank, is generated to simulate at least one angular marking signal. The at least one simulated angular marking signal is again supplied to the first counting means.

### SUMMARY OF THE INVENTION

The method of the invention is for determining a rotational position of an internal combustion engine having a camshaft and a camshaft rotational position transducer which generates a pulse signal with each pulse thereof having rising and falling flanks and the pulses of the pulse signal defining respective pulse segments (A, C, E, G). The engine further has a crankshaft and a crankshaft rotational position transducer associated therewith and the engine is provided with a camshaft transducer wheel and a control apparatus. The control apparatus has at least one configurable control apparatus input and the method includes the steps of: detecting a malfunction of the crankshaft rotational position transducer; switching the control apparatus input to an evaluation of at least one of the flanks (9.1, 10.1, 11.1, 12.1; 9.2, 10.2, 11.2, 12.2) or all flanks (9.1 to 12.1; 9.2 to 12.2) of the pulse segments (A, C, E, G); and, injecting fuel into the cylinders of the engine until an adjusting rpm gradient is detected.

With the method of the invention, a position determination of an internal combustion engine can be carried out based on the data of a transducer such as a transducer wheel assigned to the camshaft. With the aid of the method of the redundant start, an operation of the engine can be maintained, for example, by injecting fuel into one of the cylinders of the engine and this operation can be maintained until a position determination of the engine is possible via a detection of an rpm gradient.

The transducer wheels, which are assigned to camshafts of engines, are simply configured so that their cost-effective manufacture is possible. The development of a new sensor can thereby be avoided. The control routines utilized until now for the rapid start of an internal combustion engine can continue to be used unchanged without modifications being required thereon. The suggested procedure makes possible a simple synchronization of an internal combustion engine while utilizing the individual SYNC-teeth of the cylinder. By determining the SYNC-teeth of the individual cylinders, the clear determination of the corresponding cylinder is possible in each case. The determination of the corresponding cylinder can either be determined from the distance to the segment tooth or by the distance to the gap of the crankshaft transducer wheel. In contrast, a clear position determination is not given with only the assistance of the SEG-teeth (that is, the segment teeth).

In lieu of this data, the method of a redundant start of an internal combustion engine is used until, via the formation of an rpm gradient, a position determination of the engine is possible.

A configurable input can be formed at the input of the control apparatus of the internal combustion engine which can react to an increasing flank of a camshaft sensor as well as a falling flank thereof.

### BRIEF DESCRIPTION OF THE DRAWINGS

The invention will now be described with reference to the drawings wherein:

FIG. 1 shows the use of rising and falling flanks of a camshaft sensor signal for a rapid start of an internal combustion engine;

FIG. 2 shows the evaluation of only one flank of a camshaft sensor signal; and,

FIG. 3 shows the evaluation of rising and falling flanks of a camshaft sensor signal.

### DESCRIPTION OF THE PREFERRED EMBODIMENTS OF THE INVENTION

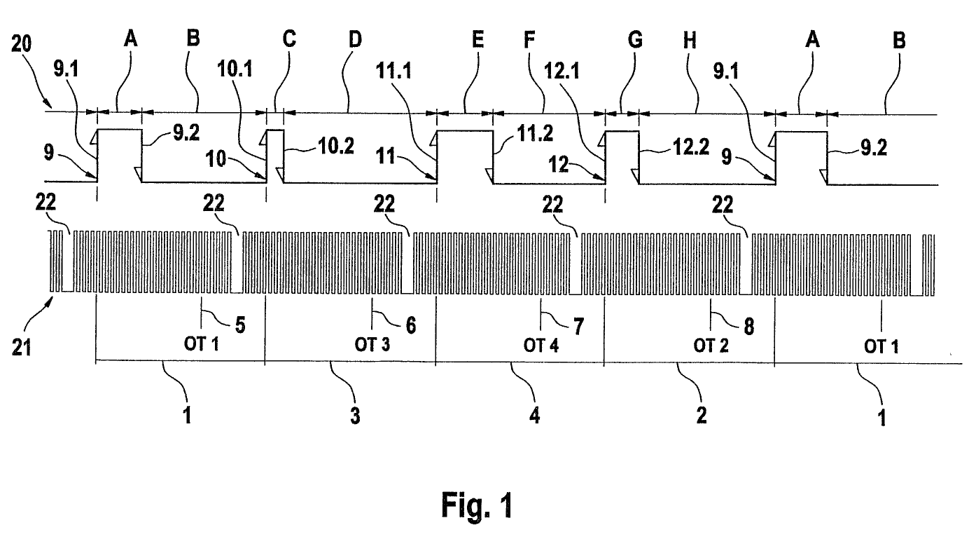

FIG. 1 shows the traces of rising and falling flanks of signal pulses which represent segment teeth of a camshaft transducer for individual cylinders of an internal combustion engine.

The trace 20 of a camshaft signal pulse and the trace 21 of an incremental signal of a crankshaft sensor are plotted one above the other for four cylinders 1, 2, 3, 4 of a four-cylinder internal combustion engine. The traces of the camshaft transducer signal 20 and of the signal 21 of the crankshaft rotational position transducer for 3, 5, 6 or 8, 10 or 12 cylinder internal combustion engines would run analog except for the condition that a larger/smaller cylinder number would have to be considered as well as pulse segments in the camshaft signal pulse trace 20 would have different pulse lengths.

According to FIG. 1, a segment tooth 9, which is assigned to the cylinder 1, is shown by a pulse segment A of the signal pulse trace 20. The length of the pulse segment A is determined by the position of its rising flank 9.1 and its falling flank 9.2. A pulse segment B extends from the falling flank 9.2 of the pulse segment A up to a rising flank 10.1 of a segment tooth 10 of cylinder 3.

The segment tooth 10 is characterized by a pulse segment C, whose length is significantly less than the length of the pulse segment A, which represents the segment tooth 9 of the cylinder 1 of the internal combustion engine.

A pulse segment D extends from the falling flank 10.2 of the segment 10 for cylinder 3 up to the rising flank 11.1 of a segment tooth 11 of the cylinder 4 of the engine. The length of the pulse segment E of the segment tooth 11 for cylinder 4 of the engine is, in turn, dimensioned greater than the pulse length of the segment tooth 10 for cylinder 3 and is also dimensioned larger than the pulse segment A of the segment tooth 9 of the cylinder 1 of the engine. From the falling flank 11.2 of segment tooth 11, a pulse segment F extends up to a rising flank 12.1 of the segment tooth 10 for the cylinder 2 of the engine. The segment tooth 12 for the cylinder 2 of the engine is characterized by the pulse segment G which is dimensioned shorter than the pulse segments A and E over the cylinders 1 and 4 of the engine, but is dimensioned longer than the pulse segment C of the segment tooth 10 of the cylinder 3 of the engine.

The pulse segment H extends from the falling flank 12.2 of the segment tooth 12 for the cylinder 2 of the engine up to the rising flank 9.1 of the segment tooth 9 for the cylinder 1 of the engine. Thereafter, a renewed passthrough of the individual segment teeth 9, 10, 11 and 12 takes place at the camshaft transducer wheel of the camshaft. This passthrough corresponds to the signal pulse trace 20.

In FIG. 1, the trace 21 of the signal of an incremental transducer is plotted parallel to the trace 20 of the pulse signal of the camshaft. Crankshaft rotational position transducer wheels are preferably used on crankshafts of internal combustion engines. These crankshaft rotational position transducer wheels are provided in a 60-2 configuration or a 60-2×2 configuration or in a 60-2×3 configuration. In this way, a signal gap arises with the passage of the tooth gap at the periphery of the crankshaft rotational position transducer wheel and this signal gap is identified by reference numeral 22 in FIG. 1. The top dead center of cylinder 1 identified by reference numeral 5 and the upper top dead center of cylinder 3 is identified by reference numeral 6. The top dead center of cylinder 4 is identified with reference numeral 7 and that of cylinder 2 of the engine with reference numeral 8.

The signal traces 20 and 21 are recorded in parallel during normal operation of an internal combustion engine having a properly operating crankshaft position rotation transducer wheel and sensor and a properly operating camshaft transducer wheel and corresponding sensor. To realize a rapid start, the following are used in normal operation: the rising flanks 9.1, 10.1, 11.1 and 12.2 of the segment teeth 9, 10, 11 and 12 as well as their corresponding falling flanks 9.2, 10.2, 11.2 and 12.2.

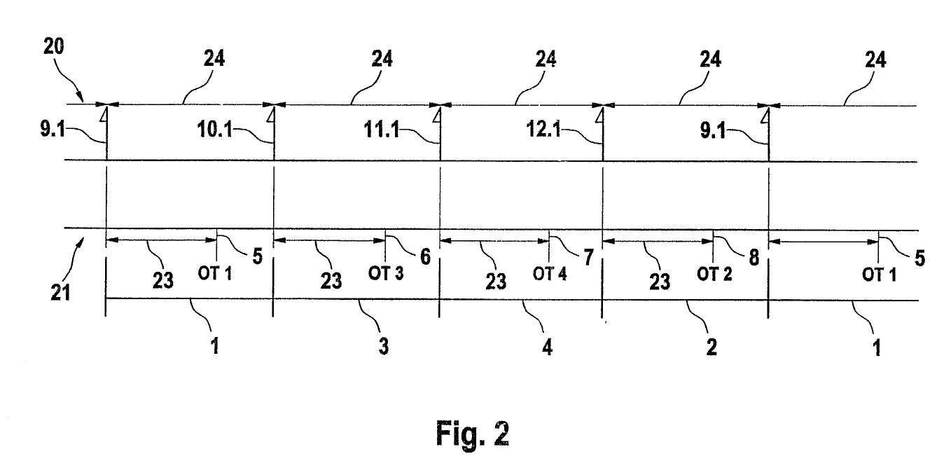

FIG. 2 shows the evaluation of only one flank of the camshaft signal pulse in a control apparatus of an internal combustion engine.

According to FIG. 2, the crankshaft sensor supplies no signal and is recognized as continuously disturbed or defective. On at least one configurable control apparatus input of the control apparatus of the internal combustion engine, the input can respond to a rising flank 9.1, 10.1, 11.1 or 12.1 of the signal of the camshaft sensor as well as to a falling flank 9.2, 10.2, 11.2 or 12.2 of the camshaft sensor signal. In FIG. 2, the additional flanks 9.1, 10.1, 11.1 or 12.1 of the camshaft sensor signal are shown as representative. According to the camshaft signal trace 20, identical spacings 24 adjust between the individual rising flanks 9.1, 10.1, 11.1, 12.1 of the segment teeth 9, 10, 11, and 12 of the cylinders 1, 2, 3, 4 of the engine. Corresponding to these intervals 24 of individually rising flanks 9.1, 10.1, 11.1 and 12.1 of the segment teeth 9, 10, 11 and 12, the respective cylinders 1, 3, 4 and 2 reach their respective top dead center points 5, 6, 7 or 8 in accordance with a defined crankshaft rotation section 23 which is fixedly pregiven by the offset of the crankshaft.

At the control apparatus, whose at least one configurable control apparatus input is switched in accordance with the illustration in FIG. 2 to the detection of the rising flanks 9.1, 10.1, 11.1 and 12.1 of respective segment teeth 9, 10, 11 and 12, the rising flanks 9.1, 10.1, 11.1 and 12.1 of the respective segment teeth 9, 10, 11 and 12 are detected in sequence at constant intervals 24. The time intervals 24 of the individual rising flanks 9.1, 10.1, 11.1 and 12.1 remain constant as long as the rpm of the engine does not change. An rpm change of the engine leads to a shortening of the time intervals 24 between the sequence of the individually rising flanks 9.1, 10.1, 11.1 and 12.1 on the configurable control input of the control apparatus. An rpm gradient adjusts, for example, when the engine is operated in accordance with the method of the redundant start in such a manner that a fuel injection is undertaken in one cylinder until a detectable rpm gradient is adjusted. A position determination can be derived from the determined rpm gradient, that is, a rotation position determination of the internal combustion engine when there is a defective crankshaft sensor can be derived only from the rotational position recorded by the camshaft.

In lieu of the detection shown in FIG. 1 of the respective rising flanks 9.1, 10.1, 11.1 and 12.1 of the corresponding segment teeth 9, 10, 11 and 12 of the cylinders 1, 2, 3, 4 of the engine, the configurable control apparatus input can be configured also to the evaluation of the respective falling flanks 9.2, 10.2, 11.2 and 12.2 of the respective individual segments 9, 10, 11 and 12.

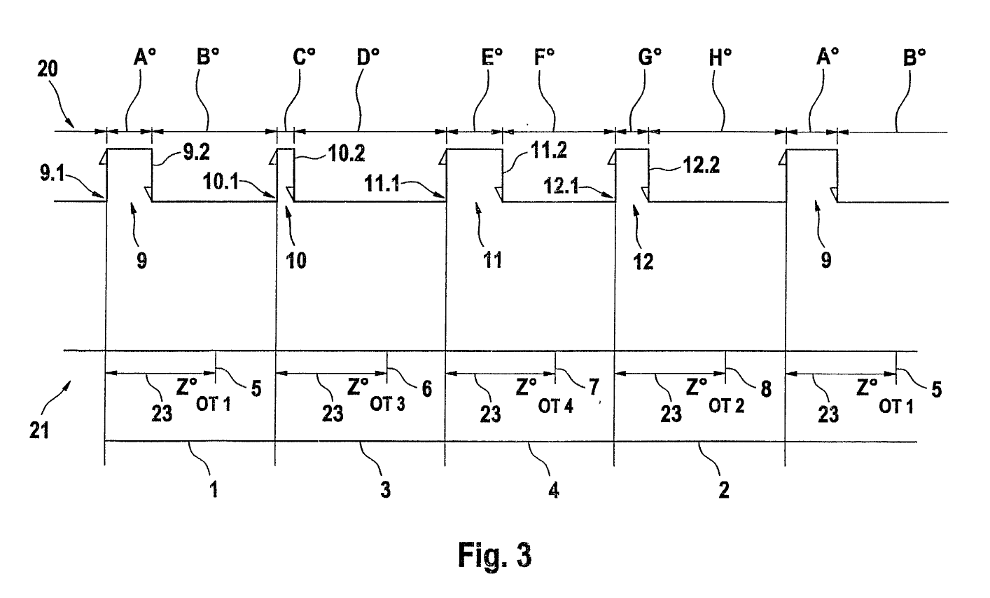

FIG. 3 shows the evaluation of rising and falling flanks of the camshaft sensor signal to arrive at an improvement of the metering accuracy.

In FIG. 3, the rising flanks 9.1, 10.1, 11.1 and 12.1 of respective segment teeth 9, 10, 11 and 12 are detected at least at a configurable control apparatus input at the control apparatus as well as their respective falling flanks 9.2, 10.2, 11.2 and 12.2. The pulse segments A, C, E and G represent the segment teeth 9, 10, 11 and 12 of the cylinders 1, 3, 4 and 2 of the engine. With the different lengths of the pulse segments of pulse segments A, C, E and G, computations for the motor dynamic can be undertaken via the camshaft segment times of all segments A, B, C, D, E, F, G and H. A correction of the injection time point of the fuel into the combustion chambers of the engine as well as a precise determination of the injection duration are possible by means of the detected segment times A, B, C, D, E, F, G and H. The computation complexity to determine the engine dynamic is correspondingly more complex because of the different segment times of all segments over a complete work cycle, that is, 720° crankshaft angle and the thereby resulting different positions of the falling flanks 9.2, 10.2, 11.2 and 12.2 of respective segment teeth 9, 10, 11 and 12.

It is understood that the foregoing description is that of the preferred embodiments of the invention and that various changes and modifications may be made thereto without departing from the spirit and scope of the invention as defined in the appended claims.

What is claimed is:

1. A method for determining a rotational position of an internal combustion engine having a camshaft and a camshaft rotational position transducer which generates a pulse signal with each pulse thereof having rising and falling flanks and the pulses of said pulse signal defining respective pulse segments (A, C, E, G) and said engine further having a crankshaft and a crankshaft rotational position transducer associated therewith and said engine being provided with a camshaft transducer wheel and a control apparatus, said control apparatus having at least one configurable control apparatus input, the method comprising the steps of:
detecting a malfunction of said crankshaft rotational position transducer;
switching said control apparatus input to an evaluation of at least one of the flanks (9.1, 10.1, 11.1, 12.1; 9.2, 10.2, 11.2, 12.2) or all flanks (9.1 to 12.1; 9.2 to 12.2) of said pulse segments (A, C, E, G); and,
injecting fuel into the cylinders of said engine until an adjusting rpm gradient is detected.

2. The method of claim 1, comprising the further step of switching said control apparatus input to an evaluation of the rising flanks (9.1, 10.1, 11.1, 12.1) of said pulse segments (A, C, E, G).

3. The method of claim 1, comprising the further step of switching said control apparatus input to an evaluation of falling flanks (9.2, 10.2, 11.2, 12.2) of said pulse segments (A, C, E, G).

4. The method of claim 1, wherein said pulse segments (A, C, E, G) of said camshaft signal pulse cover various camshaft angular regions different from each other.

5. The method of claim 1, wherein the spacings of the rising flanks (9.1, 10.1, 11.1, 12.1) of said camshaft pulse signal of the pulse segments (A, C, E, G) are identical to top dead center (OT).

6. The method of claim 1, comprising the further step of determining an rpm gradient from a comparison of the intervals (24) of rising or falling flanks (9.1, 10.1, 11. 1, 12.1; 9.2, 10.2, 11.2, 12.2) of said pulse segments (A, C, E, G) at said control apparatus input.

7. The method of claim 1, comprising the further steps of:
determining the position of the crankshaft angular position of said engine to improve the metering of fuel into the combustion chambers of said engine; and,
then switching over to rising flanks (9.1, 10.1, 11.1, 12.1) and falling flanks (9.2, 10.2, 11.2, 12.2) of said pulse segments (A, C, E, G) at said control apparatus input.

8. The method of claim 1, comprising the further steps of:
computing the engine dynamic from the detected camshaft time segment times of said pulse segments (A, B, C, D, E, F, G, H); and,
making a correction of the injection time point based on said pulse segments (A, B, C, D, E, F, G, H).

9. The method of claim 8, comprising the further step of correcting the injection duration of fuel injections into said engine from camshaft time segments of said pulse segments (A, B, C, D, E, F, G, H) present at said control apparatus.
